(19) United States
(12) Patent Application Publication
(10) Pub. No.: US 2013/0159961 A1
(43) Pub. Date: Jun. 20, 2013

(54) Method and Arrangement for Planning and/or Programming a Project of an Industrial Automation Arrangement

(71) Applicant: Edgar Frank, Nurnberg, (DE)

(72) Inventor: Edgar Frank, Nurnberg, (DE)

(73) Assignee: Siemens Aktiengesellschaft, Muenchen (DE)

(21) Appl. No.: 13/817,734

(22) PCT Filed: Aug. 18, 2010
(86) PCT No.: PCT/EP2010/062038

§ 371 Date: Feb. 19, 2013

(51) Int. Cl. G06Q 10/06

(52) U.S. Cl. CPC G06Q 10/06
USPC 717/103

(57) ABSTRACT

A method and arrangement for planning and/or programming a project of an industrial automation arrangement by a plurality of users, wherein a workstation having at least one application for the planning and/or programming is associated with each of the users, where the project comprises a plurality of objects and objects are accessed by workstations. At least a number of the objects are grouped into object groups, each of the object groups being associated with a workstation and stored in a respective physical memory of the workstation associated with the object group, a respective key being associated with each of the object groups and being stored in a data structure which is accessed by a workstation in order to access an object, the storage location information associated with the key of the associated object group being determined by the access, and the object being accessed via the storage location.

### CROSS-REFERENCE TO RELATED APPLICATIONS

This is a U.S. national stage of application No. PCT/EP2010/062038 filed 18 Aug. 2010.

### BACKGROUND OF THE INVENTION

1. Field of the Invention

The invention relates to a method for planning and/or programming a project of an industrial automation arrangement by a plurality of users, and to an arrangement for performing the method.

2. Description of the Related Art

Engineering systems are used to plan and program arrangements and installations in industrial automation. These engineering systems generally consist of a multiplicity of applications that cover the different aspects when planning and programming industrial automation arrangements. Such applications comprise, for example, aids for planning (arranging and connecting) the components (hardware planning), applications for programming controllers (PLCs=programmable logic controllers), applications for creating programs for control and monitoring devices (HMI=human machine interface), aids for planning networking, aids for programming and planning (designing) drives etc. These applications are often part of a “software suite”, i.e., these applications are part of a program package that often has a common, superordinate user interface and is installed on a an engineering workstation.

In the case of relatively large installations and projects, the development, planning and programming are often performed collaboratively by a plurality of users using a plurality of planning workstations; a multi-user system is also referred to. In this case, the programming and planning are often distributed among different developers and users, both according to functions, such as hardware planning, PLC programming or HMI programming, and within the respective functions, such as for different functions of components or for different modules in PLC programs.

In this case, each of the applications works with data that are generally also referred to as engineering data. These data may describe, for example, the planning of the hardware components, may represent relationships between individual devices and components or else may also be the programs which are created and processed when programming controllers, HMI devices etc.

The different parts of an engineering project are generally not completely independent of one another. Although subroutines or functions that are different from those, for example, in the HMI programs of the same project are called in PLC programs, for example, there are also dependencies between the individual subprojects. For example, both the PLC programs and the HMI planning or the HMI programs are generally dependent on the hardware planning. In another example, the programs that describe the screens of the control and monitoring devices (HMI screens) reference variables (tags) of the PLC programs to display them. In short, applications require at least read access but often also write access to the engineering data relating to other applications.

In order to make it possible for each application and thus for each workstation used for the planning and programming to access all required engineering data, which shall also be referred to as engineering objects or objects for short below, the multi-user systems for engineering the industrial automation arrangements have previously usually been implemented in a client/server architecture. In this case, a central server is provided and stores the respectively valid data stock of the engineering project and therefore all objects used by the applications. In this case, the workstations having the applications (also referred to as clients) request the respectively required data, which are either intended to be processed directly or to which at least read access is necessary, from the server in each case. These data are generally buffered on the workstation computers (clients) (“caching” is also referred to) in order to ensure an acceptable response time and operating speed of the respective application.

The applications likewise store changed data on the server again, after the changes have been completed and the changed data are intended to be available to other applications. All other applications and workstations that have buffered (“cached”) the corresponding data for read access must then discard the previously used data and, if necessary, retrieve the data from the server again. In this case, it is a known practice to use “concurrent version systems” (authorization management systems), check-in and check-out methods and other strategies to ensure the consistency of the data, i.e., for example, processing of (write access to) a particular object by a single application is only ever allowed, while all applications are simultaneously allowed to read the same object or the like.

However, centralizing the data stock, i.e., centrally storing the objects of an engineering project, restricts the data throughput, which results in long response times in the event of data requests and in other performance problems, in particular in the case of large engineering projects and when the workstations are distributed among different sites or even continents.

### SUMMARY OF THE INVENTION

It is therefore an object of the present invention to improve access to objects of engineering data when planning and/or programming an industrial automation arrangement by a plurality of users or workstations.

This and other objects and advantages are achieved in accordance with the invention by providing a peer-to-peer architecture instead of the conventional client/server architecture for managing data when engineering an industrial automation arrangement, a data structure which is preferably based on distributed hash tables providing information relating to the respective storage location of the objects or object groups. In this case, a distinction is preferably intended to be made between objects or object groups, rather than files of the project.

In accordance with the invention, a method is provided for planning and/or programming a project of an industrial automation arrangement by a plurality of users, where a workstation with at least one application for the planning and/or programming is respectively associated with each of the users, the project consisting of a plurality of objects, and at least one of the objects being accessed by a plurality of the workstations. In this case, at least a number of the objects is grouped into object groups, each of the object groups being associated with a workstation, the objects in an object group each being stored in a physical memory of the workstation associated with this object group, a key respectively being associated with the object groups and being stored in a data structure, the data structure specifying, for each of the keys, an identification for that workstation in whose physical memory the object group associated with the key and the objects in said group are stored, and, in order to access an object, a workstation accessing the data structure, determining the storage location information associated with the key of the associated object group using the access and accessing the object using the storage location. The use of this method results in a peer-to-peer architecture for managing data or objects when planning and/or programming a project by a plurality of users or a plurality of workstations (multi-user operation), thus making it possible to achieve a higher data throughput because not all workstations (clients) need to always access a central server to read or retrieve data or objects.

It is also an object of the invention to provide an arrangement for planning and/or programming a project of an industrial automation arrangement by a plurality of users, where a workstation with at least one application for the planning and/or programming is respectively associated with each of the users, the project consist of a plurality of objects, and at least one of the objects is able to be accessed by a plurality of the workstations. Here, the objects are grouped into object groups, the object groups with the objects being distributed among the physical memories of a plurality of workstations, a key in a data structure being associated with each object group, that workstation in whose physical memory the objects in the relevant object group are stored respectively being associated with the key in the data structure. The advantages of the method according to the invention are achieved with such an arrangement according to the invention.

The objects of the engineering data are accessed in a particularly effective manner if a distributed hash table is used as the data structure. Here, not only individual files but also individual objects within files containing a plurality of objects, on the one hand, and also groups of files with any desired number of objects, on the other hand, can be referenced as the objects. In particular, the number of table entries in the data structure or the number of required keys and therefore also the number of storage locations to be distinguished can be optimized by the possibility of referencing entire object groups rather than individual objects, which object groups are preferably thematically or functionally related to one another. In this case, one advantageous property of the distributed hash tables is that the keys can be optimally distributed to a linear range of values, with the result that it is possible to uniformly distribute the “storage load” among the workstations having the physical memories (i.e., “nodes” or “clients”). As a result of its special properties, such a data structure can be self-organizing and self-optimizing. A uniform resource locator (URL) or another item of information for finding the object can also be advantageously used as the storage location.

As in other known distributed storage solutions and, in particular, in the known peer-to-peer arrangements, it may be problematic if individual workstations or nodes temporarily or permanently fail or cannot be reached because all required data or objects are then possibly no longer available to the remaining workstations or nodes. Copies of objects or object groups are therefore advantageously stored in the physical memories of further workstations, a workstation in the form of a central server being able to hold copies of all objects or object groups in one particular embodiment. In particular, this workstation may also comprise a complete copy of the distributed hash table, which is advantageously replicated to the other workstations. This replication process must be repeated here only in those cases in which the distribution of the objects among the individual workstations is reorganized or objects are changed (by means of deletion or new creation), but not when the contents of only one object are changed, for example, as a result of processing.

For optimum access to an object being processed, which comprises both pure read access and write access, a copy of the object is advantageously loaded into a physical memory of the workstation processing or using the object, in which case the object is blocked for write access by other workstations at its original storage location in the event of write access to the object. After the processed object has been changed (“update”) at its storage location defined using a key of the data structure, all other workstations or applications which, at this time, are performing read access to this object or read access to separate copies of this object are advantageously requested to restore the data consistency in the arrangement by accessing the changed object again. For this purpose, the read access may be recorded to be able to send messages with the requests to reload the changed objects in a targeted manner.

As already mentioned, copies of objects or object groups may be transferred to further workstations, in particular to a workstation in the form of a central server, in which case the last-mentioned special workstation need not necessarily have other applications for the planning and/or programming. The storage locations of these “back-up copies” of the objects, which are intended to be used when an object is not available to its associated workstation, are advantageously likewise stored in the data structure or a further data structure, with the result that fast access to the copies is ensured. Alternatively, however, search functions may also be implemented, a first workstation sending a search message to some or all of the other workstations, the search message specifying the desired object or the desired object group. Such search messages can also be used to find objects or to restore the data structure in the event of an error or failure of the data structure.

The access to the data structure or to the objects or object groups managed therein and the accessing workstations are advantageously statistically captured, with the result that it is possible to change and optimize the storage locations of the objects and object groups at defined times (“optimization run) or continuously (“dynamically”), with the result that the number and extent of transmission of objects via a data network can be minimized and security guidelines, for example for redundantly storing important objects, can be implemented.

The number of objects associated with an object group can vary over the course of time. It is advantageously ensured that those object groups that permanently no longer have an object at all are removed from the data structure or are combined with other object groups. On the other hand, it should also be ensured that each object is also associated with an object group. In one particular embodiment, it may be advantageous if objects can also be associated with a plurality of object groups, in particular when they are objects to which only read access is regularly required. In addition, an optimization algorithm is also advantageously provided, which algorithm optimizes the group structure in such a manner that the number of groups does not become too large, on the one hand, in order to ensure fast access to the data structure, but, on the other hand, results in such finely granulated structuring that the distribution of the object groups among the workstations can be optimized with regard to storage volume and access times. For this purpose, attributes in the form of keywords or “tags”, which relate to a statement regarding functionality, access type (read or read and write) etc., are advantageously associated with the objects.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the method according to the invention are described below using the drawings. They are simultaneously used to explain an exemplary embodiment of an arrangement according to the invention, in which:

FIG. 1 shows an arrangement for planning and/or programming a project according to the prior art;

FIG. 2 shows an arrangement according to the invention having a data structure and distributed storage of objects among different workstations;

FIG. 3 shows the arrangement according to FIG. 2, in which case one of the workstations has failed or cannot be reached; and

FIG. 4 is a flowchart of the method in accordance with the invention.

### DETAILED DESCRIPTION OF THE PREFERRED EMBODIMENTS

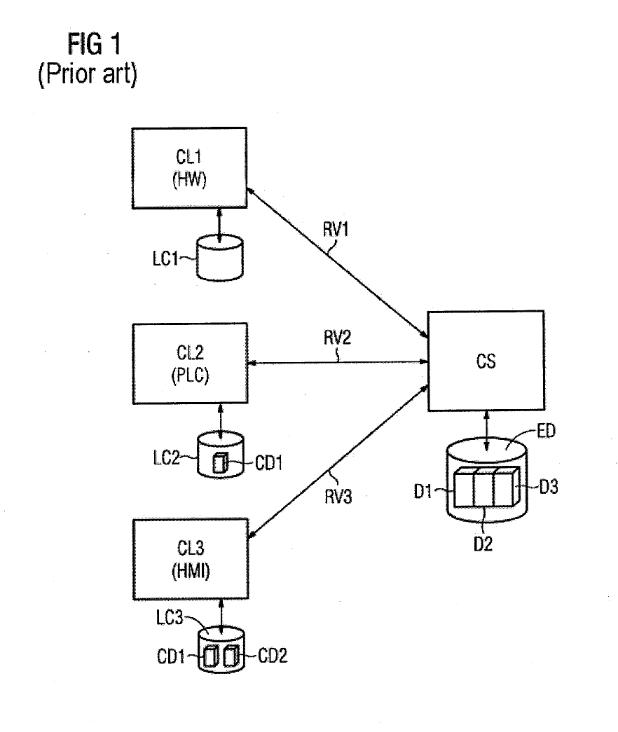

FIG. 1 illustrates an arrangement for planning and/or programming a project of an industrial automation arrangement according to the prior art. In this case, three workstations CL1, CL2, CL3 (“clients”) are provided, each comprising applications (not illustrated) for planning or programming different aspects of the automation arrangement. In this example, the workstation CL1 comprises applications for hardware planning (“HW”), the workstation CL2 comprises applications for programming controllers (“PLC”), and the third workstation CL3 comprises applications and aids for programming and planning monitoring and control devices (“HMI”). A fourth workstation CS (“central server”) does not comprise any applications for planning and/or programming, but rather is a server having a database ED (“engineering data”) which comprises the engineering data relating to a project. In this case, a distinction is intended to be made below between three object groups D1, D2, D3 each having a multiplicity of objects; in this example, the objects in the object group D1 relate to the hardware planning, the objects in the object group D2 relate to the programming of the controllers and the objects in the object group D3 relate to the hardware and software planning or programming of control and monitoring devices. A physical memory LC1, LC2, LC3 (“local cache”), i.e., for example, a hard disk memory of the workstation used in each case or of the personal computer used in each case is respectively associated with the workstations CL1, CL2, CL3. Copies CD1, CD2 of the object groups D1, D2, D3 may be loaded into these storage devices LC1, LC2, LC3 if and as long as they are used by the respective application in the respective workstation CL1, CL2, CL3. This use relates both to pure read access and to read and write access. During processing of a copy CD1, CD2 of an object group D1, D2, D3 or of the objects contained in the latter object groups D1, D2, D3, which is generally concluded with write access, the object groups D1, D2, D3 or the objects affected by the object groups D1, D2, D3 are protected against other write access in the engineering database ED. After write access has ended, i.e., after a copy CD1, CD2 has been processed, the changed data are restored to the engineering database ED, and other applications that are currently using copies CD1, CD2 for pure read access are requested to read the corresponding object group D1, D2, D3 or the affected objects again. Logical data connections RV1, RV2, RV3 are provided, via a data network (not illustrated), for the purpose of transmitting the copies CD1, CD2.

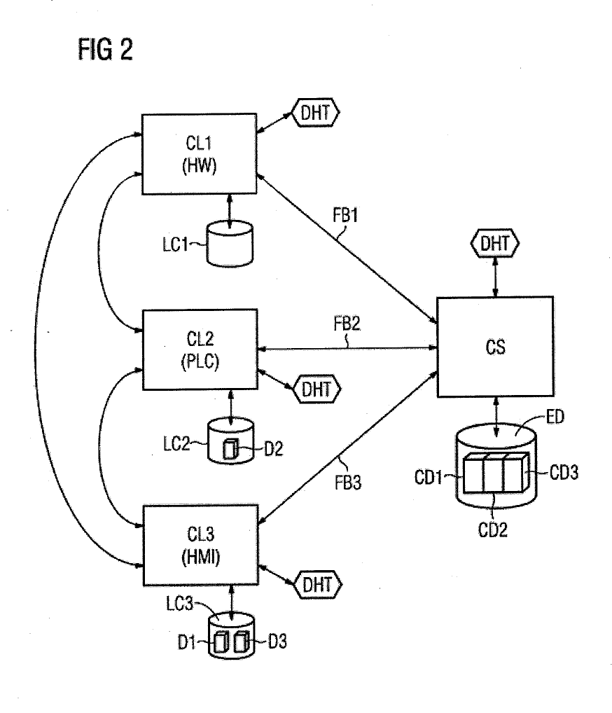

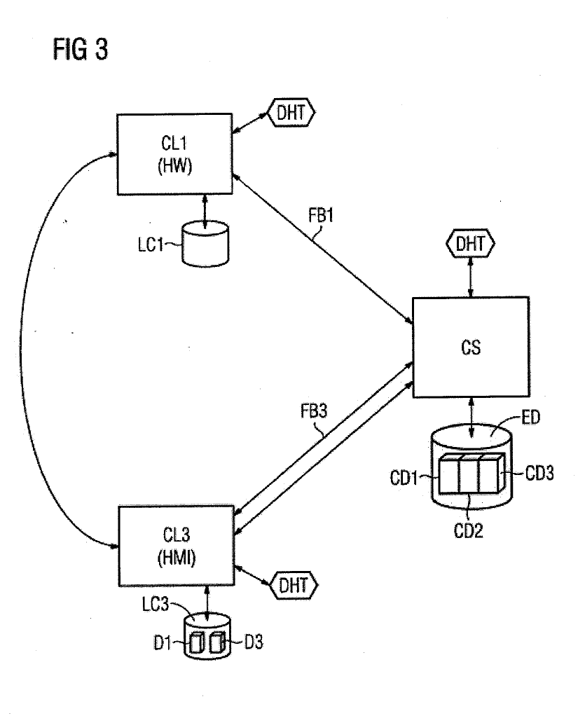

FIG. 2 illustrates an arrangement according to the invention which is based, in principle, on the arrangement according to the prior art explained using FIG. 1, with the result that all components and objects with reference signs which are already known from FIG. 1 are not reintroduced and described here. The same also applies to FIG. 3 which is discussed later.

In the arrangement according to FIG. 2, the workstations CL1, CL2, CL3 are configured such that they can directly interchange data, in particular objects and object groups D1, D2, D3 or copies CD1, CD2, CD3, with one another; the logical connections required for this purpose are indicated on the left-hand edge of the image using double arrows. The workstations CL1, CL2, CL3 and the workstation CS with the central server now have each stored a copy of a distributed hash table DHT or have access to such a distributed hash table DHT which comprises details of the current storage location of the objects in the respective object group D1, D2, D3 in the form of a data structure using keys which are associated with each object group D1, D2, D3. Copies CD1, CD2, CD3 of all object groups are stored in the engineering database ED, i.e., in a main memory of the workstation CS, these copies being available, via the data connections FB1, FB2, FB3 (“fall back”), for the situation in which the workstations CL1, CL2, CL3 cannot provide mutually required objects or object groups D1, D2, D3.

The exemplary embodiment described according to FIG. 2 illustrates a state in which the object groups D1, D3 are stored in the physical memory LC3 of the workstation CL3, and the object group D2 is stored in the storage area LC2 of the workstation CL2. This may be explained, for example, by the fact that, after hardware planning has been concluded, the associated engineering data relating to the object group D1 are predominantly used by the workstation CL3 (HMI programming). A monitoring entity which may be arranged on any desired hardware component of the arrangement has determined here, for example, that the object group D1 is or was predominantly accessed by the workstation CL3, after which the object group D1 was caused to be stored in a main memory LC3 of the workstation CL3 and the new storage location was associated therewith in a manner corresponding to the associated key in the data structure, i.e., the distributed hash table DHT. If, for example, an application in the workstation CL2 now requires access to the objects in the object group D1, access to the data structure of the distributed hash table DHT returns the information that the corresponding object group D1 is stored in the physical memory LC3 of the workstation CL3. For access, the application in the workstation CL2 then requests a copy of the object group D1 from the workstation CL3, after which the object group D1 in the storage area LC3 is retrieved and is transmitted, as a copy, to the workstation CL2; this operation is not illustrated in FIG. 2.

In addition to the copies CD1, CD2, CD3 in the engineering database ED, further copies of the object groups D1, D2, D3 may also be additionally stored in storage areas of any desired other workstations; this state is not illustrated in FIG. 2 either for reasons of clarity.

FIG. 3 illustrates the state which results when, starting from the state in FIG. 2, the workstation CL2 can no longer be reached via a data network or is switched off or can no longer perform its function for another reason. It is assumed that the workstation CL3 now requires access to objects in the object group D2. However, access to the data structure of the distributed hash table DHT reveals here that retrieval of the corresponding data from the workstation CL2 is intended to be possible. However, since such a connection cannot be set up, it is necessary to access the copy CD2 of the object group D2. In the present exemplary embodiment, the storage locations of the copies CD1, CD2, CD3 can also be retrieved using a key associated with the desired data. In an alternative exemplary embodiment (not illustrated), however, the workstation CL3 can also transmit search messages to the workstations CL1, CS, in which case the workstation CS, i.e., the central server with the copies CD1, CD2, CD3 in the engineering database ED, would respond to this search message at least in such a case and would provide the copy CD2. At the same time, the copy CD2 of the object group D2 present in the engineering database ED is treated as an “original” at least for the duration for which the workstation CL2 cannot be reached, i.e., the version present in the component that cannot be reached, i.e., the workstation CL2, is marked as invalid in the data structure. However, in the present exemplary embodiment, this applies only to the situation in which the workstation CL3 or an application running in the latter carries out write access to the objects in the object group D2; in the case of pure read access, the “original” of the object group D2 can still remain valid in the version present in the storage area LC2 of the workstation CL2.

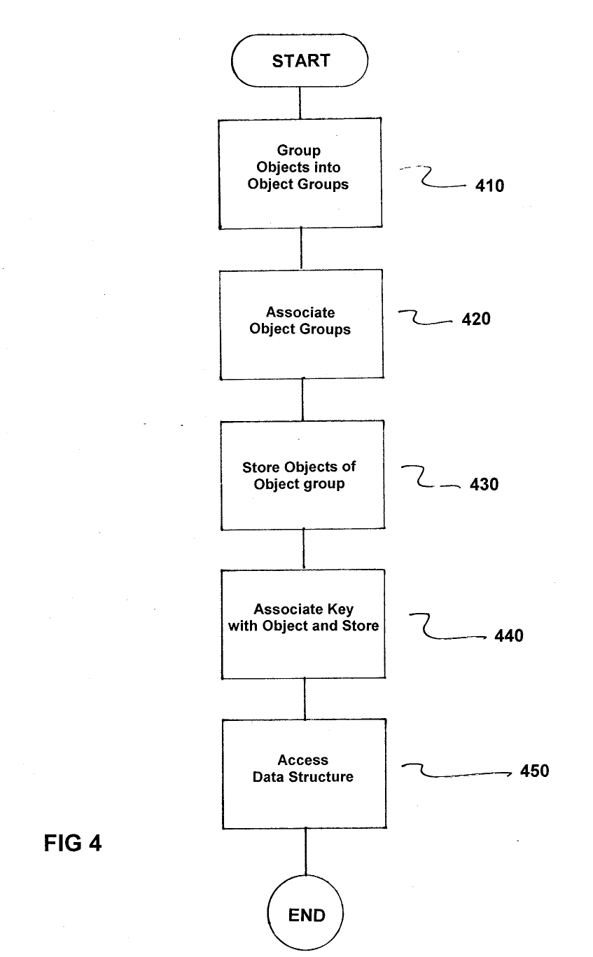

FIG. 4 is a flow chart of a method for planning and/or programming a project of an industrial automation arrangement by a plurality of users, where a workstation includes at least one application for the planning and/or the programming respectively associated with each of the users, and the project consists of a plurality of objects, and where at least one object of the plurality of objects is accessed by a plurality of the workstations. The method comprises grouping at least a number of the plurality of objects into object groups, as indicated in step 410.

Next, each of the object groups is associated with a workstation, as indicated in step 420.

Each of the objects in an object group are stored now in a physical memory of the workstation associated with this object group, as indicated in step 430.

Next, a key is associated with each respective object in the object group and each respective associated key is stored in a data structure which specifies, for each respective associated key, an identification for that workstation in whose physical memory the object group associated with the key and the objects in the object group are stored, an indicated in step 440.

A workstation then accesses the data structure by determining a storage location information associated with the key of the associated object group using the access and accesses the object using the storage location, as indicated in step 450.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A method for at least one of planning and programming a project of an industrial automation arrangement by a plurality of users, a workstation including at least one application for at least one of the planning and the programming respectively being associated with each of the users, the project consisting of a plurality of objects, and at least one of the objects of the plurality of objects being accessed by a plurality of the workstations, the method comprising the steps of:
grouping at least a number of the plurality of objects into object groups;
associating each of the object groups with a workstation;
storing each of the objects in an object group in a physical memory of the workstation associated with this object group;
associating a key with each respective object in the object group and storing each respective associated key in a data structure which specifies, for each respective associated key, an identification for that workstation in whose physical memory the object group associated with the key and the objects in said object group are stored; and
accessing, by a workstation, the data structure by determining a storage location information associated with the key of the associated object group using the access and accessing the object using said storage location.

16. The method as claimed in claim 15, wherein a distributed hash table is used as the data structure.

17. The method as claimed in claim 15, further comprising:
loading a copy of the object into a physical memory of the processing workstation and the object is blocked for write access by other workstations to process the object.

18. The method as claimed in claim 15, wherein said grouping step is implemented utilizing one of an application associated with the objects, a function and a function group of the industrial automation arrangement associated with the objects.

19. The method as claimed in claim 15, wherein copies of one of the objects and object groups are stored in physical memories of further workstations.

20. The method as claimed in claim 19, wherein the data structure stores information relating to storage locations of the copies of one of the objects and object groups, the copy being accessed in cases in which the workstation associated with one of the objects and object groups cannot be reached.

21. The method as claimed in claim 19, wherein a workstation comprising a central server is utilized as the storage location for the copies.

22. The method as claimed in claim 21, wherein the central server comprises a copy of at least one of all objects and all object groups of the project.

23. The method as claimed in claim 1, wherein the access to one of the objects and object groups and an accessing workstation are statistically captured, the association of the objects with the workstations being optimized using resultant statistical data.

24. The method as claimed in claim 15, wherein at least one object is associated with each of the object groups, and wherein each object is associated with an object group.

25. An arrangement for at least one of planning and programming a project of an industrial automation arrangement by a plurality of users, the arrangement comprising:
a workstation including at least one application for at least one of the planning and the programming respectively associated with each of the plurality of users, the project comprising of a plurality of objects, and at least one object of the plurality of objects being accessible by a plurality of the workstations;
wherein the objects are grouped into object groups;
wherein the object groups with the objects are distributed among physical memories of the plurality of workstations; and
wherein a key in a data structure is associated with each object group, that workstation in whose physical memory the objects in a relevant object group are stored respectively being associated with the key in the data structure.

26. The arrangement as claimed in claim 25, wherein the data structure is a distributed hash table.

27. The arrangement as claimed in claim 25, wherein some or all of the objects are stored as a copy in the physical memory of a workstation other than the workstation with which the same or all objects are associated, a storage location of the copy respectively being retrievable from the data structure.

28. The arrangement as claimed in claim 26, wherein some or all of the objects are stored as a copy in the physical memory of a workstation other than the workstation with which the same or all objects are associated, a storage location of the copy respectively being retrievable from the data structure.

29. The arrangement as claimed in patent claim 27, wherein one workstation of the plurality of workstations is a central server comprising copies of all objects of the project.
